(19) United States
(12) Patent Application Publication
(10) Pub. No.: US 2011/0320302 A1
(43) Pub. Date: Dec. 29, 2011

(54) Service auction application utilizing smart phones or computer

(76) Inventor: Malak Seriani, New Milford, NJ (US)

(21) Appl. No.: 13/049,379

(22) Filed: Mar. 16, 2011

Related U.S. Application Data
(60) Provisional application No. 61/358,037, filed on Jun. 24, 2010.

(51) Int. Cl. G06Q 30/00

(52) U.S. Cl. 705/26.3

(57) ABSTRACT

Embodiments of the disclosed technology, by way of a bidirectional communication, allow a user of a handheld device with phone and/or data service to submit a request for bid for transport service, a registered user in a specific geography may respond to requests for bids.

### CROSS-REFERENCE TO RELATED APPLICATIONS

This is related to previously filed application No. 61/358,037 filed on Jun. 24, 2010.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention will allow users to request bids for services such as taxi, limousine or transporting a car. Currently such service does not exist.

### BRIEF SUMMARY OF THE INVENTION

Application will allow unregistered users with either a smart phone or interne access to request bids for transport service between 2 chosen locations, registered fee paying users will be able to respond to bid requests in their pre-defined grid in a pre-set time. The application will forward the lowest 4 bids to the unregistered user who can select a provider. Current applications only show service providers in a geographic location with approximate cost of service. There is a need for service where unregistered users can submit request for service and receive bids back from registered users, the responses will contain rating of the bidders by previous users. The unregistered user remains anonymous to the bidder until he/she decides to contact a bidder directly.

### BRIEF DESCRIPTION OF THE SEVERAL VIEWS OF THE DRAWING

Not Applicable.

### DETAILED DESCRIPTION OF THE INVENTION

The present invention may be accessed via web, or, it can be installed on a mobile smart phone. If used through a mobile smart phone, an unregistered user can download the application free of charge, when the application is invoked, it detects the user's location via GPS, the user will have the option to modify the location detected by GPS, that location will be referred to as the “From” Location, the user will need to enter a destination location, which will be referred to as the “To” location, by entering city and state, or, airport code. The user will also need to identify date and time service is requested. The user will have the option to select type of car needed (Sedan, Limo, Van . . . ). The user will request bids to his service by hitting submit button. If the user is submitting a request to transfer a vehicle, he/she will have to specify type of vehicle to be transported. Request will be sent to a fee paying registered users either through text message or any other available messaging application. The request will be sent to registered users based on the “From” and “To” locations. Registered users are assigned a specific geography. Registered users will have a pre-determined time to respond with their bids, the unregistered user remains anonymous to the registered users responding to the service request. The program will analyze responses and forward a pre-determined number of the lowest bids to the unregistered user. The response will contain, company name, location, Telephone number, bid amount and rating as entered by previous unregistered users. If interested, the unregistered user can contact a bidder directly to provide detailed “From” and “To” locations. The responded bids will remain active for a pre-determined time.

The user will have the option of entering feedback and rating on the winning bidder. The application will offer history views to both registered and unregistered users. If the invention is used through a computer, it will offer the same features except for pre-populating the “From” location, this field will have to be entered manually.

1. A computer program for automatically selecting a list of service providers in a specific geography that meet criteria for a specific service request. The program will automatically distribute the service request to the selected list. The program will automatically select a pre-set number of lowest bids and respond back to the user requesting the service. The program can be invoked via a mobile smart phone or a computer
